(19) United States
(12) Patent Application Publication
(10) Pub. No.: US 2020/0051480 A1
(43) Pub. Date: Feb. 13, 2020

(54) DISPLAY APPARATUS

(71) Applicant: Au Optronics Corporation, Hsinchu (TW)

(72) Inventors: Che-Chia Chang, Hsinchu City (TW); Ming-Hung Chuang, Tainan City (TW); Ming-Hsien Lee, Hsinchu City (TW); Chun-Fu Chung, Hsinchu (TW)

(73) Assignee: Au Optronics Corporation, Hsinchu (TW)

(21) Appl. No.: 16/513,737

(22) Filed: Jul. 17, 2019

Related U.S. Application Data
(60) Provisional application No. 62/717,260, filed on Aug. 10, 2018.

(30) Foreign Application Priority Data
Jan. 28, 2019 (TW) 108103140

(51) Int. Cl. G09G 3/20

(52) U.S. Cl. CPC G09G 3/20; G09G 2310/0251; G09G 2310/0297

(57) ABSTRACT

A display apparatus includes a plurality of pixel lines, a multiplexer, a first switch and a second switch. The pixel lines are respectively coupled to a plurality of data lines. The data lines include a first selected data line, a second selected data line and a plurality of other data lines. The first switch is coupled between the first selected data line and a first non-selected data line among the other data lines and is turned on or turned off according to a first control signal. The second switch is coupled between the first selected data line and a second non-selected data line among the other data lines and is turned on or cut off according to a second control signal.

### CROSS-REFERENCE TO RELATED APPLICATION

This application claims the priority benefits of U.S. provisional application Ser. No. 62/717,260, filed on Aug. 10, 2018, and Taiwan application serial no. 108103140, filed on Jan. 28, 2019. The entirety of each of the above-mentioned patent applications is hereby incorporated by reference herein and made a part of this specification.

### BACKGROUND

### Field of the Invention

The invention relates to a display apparatus and more particularly, to a display apparatus capable of enhancing charging performance of display pixels.

### Description of Related Art

Referring to FIG. 1, FIG. 1 is a schematic diagram illustrating a display apparatus of the related art. In a display apparatus 100 of the related art, in order to reduce a size under a boundary of a panel, a multiplexer 110 is disposed above a display panel. In this way, in a wiring manner of a selected data line S1 connected with a source driver, below the display panel, the selected data line S1 passes through a region (i.e., a region in which display pixels P11 to PN3 are distributed) in a pixel array and is connected to multiplex switches S1 and S2 in the multiplexer 110 to be coupled to non-selected data lines D-2 and D-1 respectively via the multiplex switches S1 and S2, wherein the multiplex switches S1 and S2 are respectively controlled by multiplex control signals SW1 and SW2.

When an operation of writing display data is to be performed on one of the display pixels P11 and P21 to PN1 on the non-selected data line D-1, the multiplex switch S2 is turned on through the multiplex control signal SW2, and the display data, according to a path PH1, passes through the region in the pixel array from the selected data line S1, and is transmitted to the corresponding display pixels P11 and P21 to PN1 via the turned-on multiplex switch S2 and then through the non-selected data line D-1.

It is not difficult to find out from the above description that the path PH1 has a long length and a certain degree of signal transmission impedance. In this way, the efficiency of writing the display data of the display pixels is unavoidably influenced within a limited time for writing the pixel data.

### SUMMARY

The invention provides a display apparatus that can improve the efficiency of charging/discharging pixels.

A display apparatus of the invention includes a plurality of pixel lines, a multiplexer, a first switch and a second switch. The pixel lines are respectively coupled to a plurality of data lines. The data lines include a first selected data line, a second selected data line and a plurality of other data lines. The first switch is coupled between the first selected data line and a first non-selected data line among the other data lines and is turned on or turned off according to a first control signal. The second switch is coupled between the first selected data line and a second non-selected data line among the other data lines and is turned on or cut off according to a second control signal.

To sum up, the invention, with the switches disposed between the selected data lines and the non-selected data lines and the time zones in which the switches are turned on, can achieve pre-charging the display pixels on the selected data line and those on the corresponding non-selected data line by sharing charges, so as to improve the efficiency of charging the display pixels.

To make the above features and advantages of the invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a display apparatus of the related art.

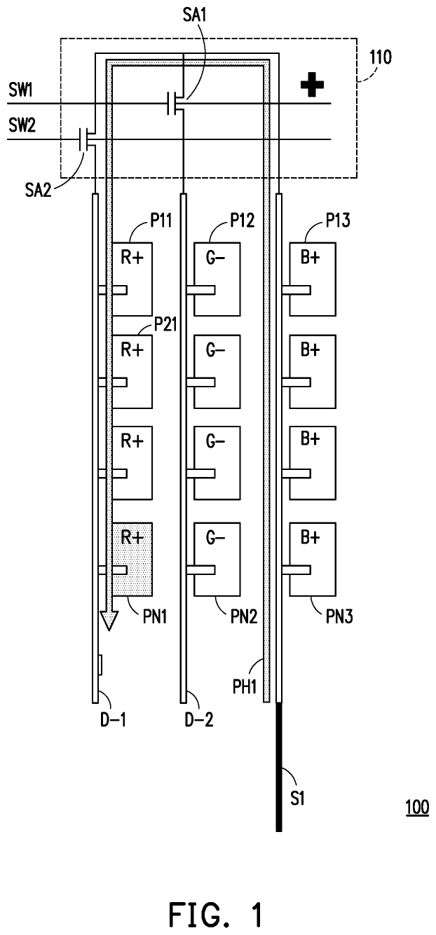

FIG. 2 is a schematic diagram illustrating a display apparatus according to an embodiment of the invention.

FIG. 3A through FIG. 3C are operation waveform graphs respectively illustrating different implementation manners of embodiments of the invention.

FIG. 4 is a schematic waveform graph of a display apparatus according to another embodiment of the invention.

FIG. 5 is a schematic diagram illustrating a display apparatus according to another embodiment of the invention.

FIG. 6 is a schematic diagram illustrating a display apparatus according to yet another embodiment of the invention.

FIG. 7A and FIG. 7B respectively illustrate disposition position relationships among a multiplexer, a plurality of pixel lines and switches according to different embodiments of the invention.

FIG. 8 is a schematic diagram illustrating a display apparatus according to yet another embodiment of the invention.

### DESCRIPTION OF EMBODIMENTS

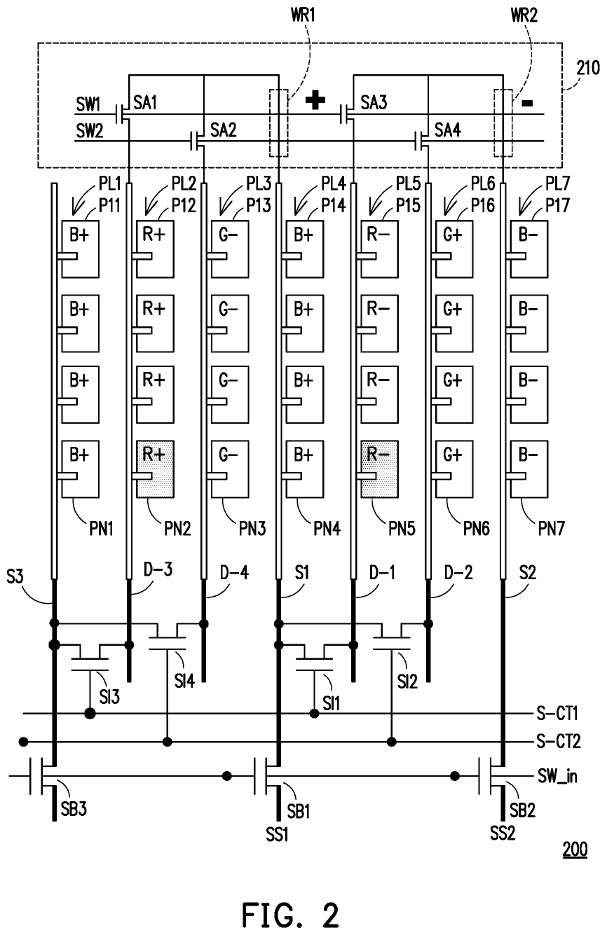

Referring to FIG. 2, FIG. 2 is a schematic diagram illustrating a display apparatus according to an embodiment of the invention. A display apparatus 200 includes pixel lines PL1 to PL7, a multiplexer 210 and switches SI1 and SI2. The pixel lines PL1 to PL7 are respectively coupled to a plurality of data lines, and the data lines include selected data lines S1 to S3 and a plurality of other non-selected data lines D-1, D-2, D-3 and D-4. In the present embodiment, the pixel lines PL1 to PL7 are respectively coupled to the selected data line S3, the non-selected data line D-3, the non-selected data line D-4, the selected data line S1, the non-selected data line D-1, the non-selected data line D-2 and the selected data line S2. The selected data lines S1 to S3 are directly connected to a source driver (not shown), and the non-selected data lines D-1 to D-4 are not directly connected to the source driver. The present embodiment also includes data transmission switches SB1, SB2 and SB3, wherein the data transmission switches SB1 and SB2 respectively transmit display data SS1 and display data SS2 to the pixel lines PL4 and PL7. The data transmission switches SB1, SB2 and SB3 are controlled by a data transmission control signal SW_in.

Moreover, the multiplexer 210 is disposed above the pixel lines PL1 to PL7 and controlled by multiplex control signals SW1 and SW2. In the present embodiment, the multiplexer 210 is coupled to the selected data lines S1 and S2 and non-selected data lines D-1 to D-4. Additionally, the multiplexer 210 includes multiplex switches SA1 to SA4 and transmission wires WR1 and WR2. In the present embodiment, the transmission wire WR1 is directly coupled to the selected data line S1 and coupled to first terminals of the multiplex switches SA1 and SA2. Second terminals of the multiplex switches SA1 and SA2 are respectively coupled to the non-selected data lines D-3 and D-4. Additionally, the transmission wire WR2 is directly coupled to the selected data line S2 and coupled to first terminals of the multiplex switches SA3 and SA4. Second terminals of the multiplex switches SA3 and SA4 are respectively coupled to the non-selected data lines D-1 and D-2.

The switch SI1 is disposed between the selected data line S1 and the non-selected data line D-1, and the switch SI2 is disposed between the non-selected data lines D-1 and D-2. The switches SI1 and SI2 are respectively controlled by control signals S-CT1 and S-CT2 to be turned on or turned off. On the other hand, a switch SI3 may also be disposed between the selected data line S3 and the non-selected data line D-3, and a switch SI4 may also be disposed between the non-selected data lines D-3 and D-4. The switches SI3 and SI4 are respectively controlled by control signals S-CT1 and S-CT2 to be turned on or turned off.

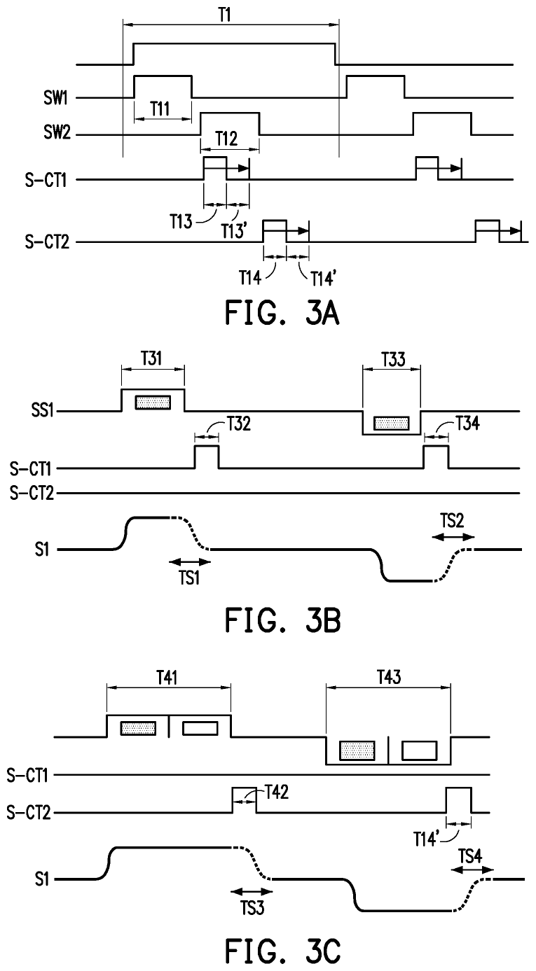

In regard to the operation of the display apparatus 200, with reference to FIG. 2 and FIG. 3A through FIG. 3C simultaneously, FIG. 3A through FIG. 3C are operation waveform graphs respectively illustrating different implementation manners of embodiments of the invention. In FIG. 3A, during a sub time zone T11 in a time zone T1, the multiplex switches SA3 and SA1 are turned on according to the multiplex control signal SW1 which is enabled (while the multiplex switches SA2 and SA4 are turned off). The display data SS1 and the display data SS2 may be transmitted to the selected data lines S1 and S2 respectively via the data transmission switches SB1 and SB2 which are turned-on. Via the multiplex switches SA1 and SA3 which are turned on, the display data SS1 and the display data SS2 may be written into display pixels (e.g., display pixels PN2 and PN5) through the non-selected data lines D-3 and D-1.

Thereafter, during a sub time zone T12 in the time zone T1, the multiplex control signal SW1 is transited to be disabled, the multiplex control signal SW2 is transited to be enabled, and the multiplex switches SA3 and SA1 are turned off according to the multiplex control signal SW1 (while the multiplex switches SA2 and SA4 are turned on). During a former stage of a sub time zone T13 in which the multiplex control signal SW2 is transited to be enabled, the control signal S-CT1 is transited to be enabled to turn on the switches SI1 and SI3. In this way, taking the display data SS1 as an example, the display data SS1 may be not only written into the display pixels of the pixel line PL3 through the selected data line S1 via the multiplex switch SA2, but also transmitted to the non-selected data line D-1 via the switch SI1, thereby pre-charging the display pixels on the pixel line PL5 through the non-selected data line D-1.

Then, after the sub time zone T12 ends, in a sub time zone T14, the control signal S-CT1 may be transited to be enabled to turn on the switches SI2 and SI4. By the operation of turning on the switches SI2 and SI4, the display pixels of the pixel lines PL6 and PL3 respectively corresponding to the non-selected data lines D-2 and D-4 may be pre-charged by the display data on the selected data lines S1 and S3.

It may be learned according to the description above that the display apparatus 200 of the embodiments of the invention may directly pre-charge the display pixels in an adaptive time via the switches SI1 to SI4 disposed therein, so as to improve the efficiency of charging the display pixels.

It should be additionally mentioned that in the embodiments of the invention, a length of time in which the switches SI1, SI3 and the switches SI2, SI4 are turned on may be dynamically adjusted. A designer may, according to actual requirements, adjust the sub time zone T13 illustrated in FIG. 3A as a sub time zone T13′ and adjust the sub time zone T14 as a sub time zone T14′.

In the embodiments of the invention, the display pixels P11 to PN7 of the pixel lines PL1 to PL7 may be used to generate different display colors and correspond to different driving polarities. For instance, a display color in blue (B) is generated by the pixel lines PL1, PL4 and PL7, a display color in red (R) is generated by the pixel lines PL2 and PL5, a display color in green (G) is generated by the pixel lines PL3 and PL6. When the driving polarities of the pixel lines PL1, PL2, PL4 and PL6 are positive, the driving polarities of the pixel lines PL3, PL5 and PL7 are negative.

Moreover, in FIG. 3B, when the display apparatus 200 performs a data writing operation on red pixels, in a time zone T31, the display data SS1 (e.g., red display data) with the positive polarity is transmitted and provided to the selected data line S1, and a signal strength of the selected data line S1 is increased along with the display data SS1 in the time zone T31. Thereafter, after a sub time zone T31 ends, the signal strength of the selected data line S1 is gradually decreased. In a time zone T32 corresponding to a process in which the signal strength of the selected data line S1 is increased, the switch SU is turned on according to the control signal S-CT1 which is enabled. In this way, in a charge sharing time zone TS1 when the charges are shared during the process of the signal strength of the selected data line S1 being decreased, the electric energy of the selected data line S1 may be transmitted to the non-selected data line D-1, thereby positively pre-charging the display pixels on the non-selected data line D-1.

Thereafter, in a time zone T33, the display data SS1 (e.g., red display data) with the negative polarity is transmitted and provided to the selected data line S1, and the signal strength of the selected data line S1 is pulled down along with the display data SS1 in the time zone T31. Thereafter, after a sub time zone T33 ends, the signal strength of the selected data line S1 is gradually increased. In a sharing time zone T34 corresponding to a process of the signal strength of the selected data line S1 being increased, the switch SI1 is turned on according to the control signal S-CT1 which is enabled. In this way, in a charge sharing time zone TS2 during the process of the signal strength of the selected data line S1 being increased, the electric energy of the selected data line S1 may be transmitted to the non-selected data line D-1, thereby negatively pre-charging the display pixels on the non-selected data line D-1.

In FIG. 3C, when the display apparatus 200 performs a data writing operation on the red and green pixels, in a time zone T41, the display data SS1 with the positive polarity which sequentially includes the display data in red and the display data in green is transmitted and provided to the selected data line S1, and the signal strength of the selected data line S1 is increased along with the display data SS1 in the time zone T41. After the time zone T41 ends, the signal strength of the selected data line S1 is gradually decreased. In a time zone T42 following the time zone T41, the switch SI2 is turned on according to the control signal S-CT2 which is enabled. In this way, in a charge sharing time zone TS3 during the process of the signal strength of the selected data line S1 being decreased, the electric energy of the selected data line S1 may be transmitted to the non-selected data line D-2, thereby positively pre-charging the display pixels on the non-selected data line D-2.

Thereafter, in a time zone T43, the display data SS1 with the negative polarity which sequentially includes the display data in red and the display data in green is transmitted and provided to the selected data line S1, and the signal strength of the selected data line S1 is pulled down along with the display data SS1 in the time zone T43. After the time zone T43 ends, the signal strength of the selected data line S1 is gradually increased. Then, in a time zone T44 following the time zone T43, the switch SI2 is turned on according to the control signal S-CT2 which is enabled. In this way, in a charge sharing time zone TS4 during the process of the signal strength of the selected data line S1 being increased, the electric energy of the selected data line S1 may be transmitted to the non-selected data line D-2, thereby negatively pre-charging the display pixels on the non-selected data line D-2.

It may be learned according to the description above that in the embodiments of the invention, a timing for turning on the switches SI1 and SI2 is as follows. When the selected data line S1 sequentially transmits first color display data and second color display data, and when a strength of the first color display data is greater than a strength of the second color display data, the switch SI1 is turned on according to the control signal S-CT1 in a first time zone. The first time zone occurs in a transition time zone when a signal on the first selected data line S1 is transited from the first color display data to the second color display data, i.e., the charge sharing time zones TS1 and TS2 as illustrated in FIG. 3B.

In addition, when the selected data line S1 transmits third color display data after the second color display data, and when the strength of the second color display data is greater than a strength of the third color display data, the switch SI2 may be turned on according to the control signal S-CT2 in a second time zone. The second time zone occurs in a transition time zone when the signal on the first selected data line S1 is transited from the second color display data to the third color display data, i.e., the charge sharing time zones TS3 and TS4 as illustrated in FIG. 3C.

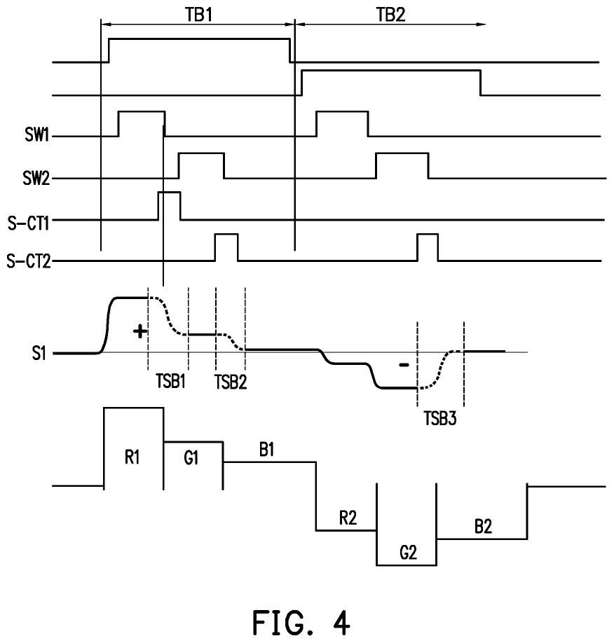

Then, referring to FIG. 2 and FIG. 4, FIG. 4 is a schematic waveform graph of a display apparatus according to another embodiment of the invention. In FIG. 4, a scenario that the selected data line S1 sequentially transmits a plurality of display data R1, G1 and B1 in different colors with positive polarity in a time zone TB1 and sequentially transmits the display data R1, G1 and B1 in different colors with negative polarity in a time zone TB2 is taken as an example. In the time zone TB1, the multiplex switches SA3 and SA4 are sequentially turned on according to the multiplex control signals SW1 and SW2 which are sequentially enabled. Additionally, in a time zone that the multiplex control signal SW1 is transited to be disabled and the multiplex control signal SW2 is transited to be enabled, the switch SI1 is turned on according to the control signal S-CT1 based on the strength of the display data R1 being greater than the strength of the display data G1, and the display pixels on the non-selected data line D-1 may be pre-charged by the electric energy on the selected data line S1 via the switch SI1 during a charge sharing time zone TSB1.

Additionally, according to the multiplex control signal SW2 being transited to be disabled, the switch SI2 is turned on according to the control signal S-CT2 based on the strength of the display data G1 being greater than the strength of the display data B1, and the display pixels on the non-selected data line D-2 may be pre-charged by the electric energy on the selected data line S1 via the switch SI2 during a charge sharing time zone TSB2.

In a time zone TB2, the multiplex switches SA3 and SA4 are sequentially turned on according to the multiplex control signals SW1 and SW2 which are sequentially enabled. In addition, it should be noted that in the time zone that the multiplex control signal SW1 is transited to be disabled and the multiplex control signal SW2 is transited to be enabled, the switch SI1 is not turned on based on a strength of display data R2 being smaller than a strength of display data G2.

Thereafter, according to the multiplex control signal SW2 being transited to be disabled, the switch SI2 is turned on according to the control signal S-CT2 based on the strength of the display data G2 being greater than the strength of the display data B2, and the display pixels on the non-selected data line D-2 may be pre-charged by the electric energy on the selected data line S1 via the switch SI2 during a charge sharing time zone TSB3.

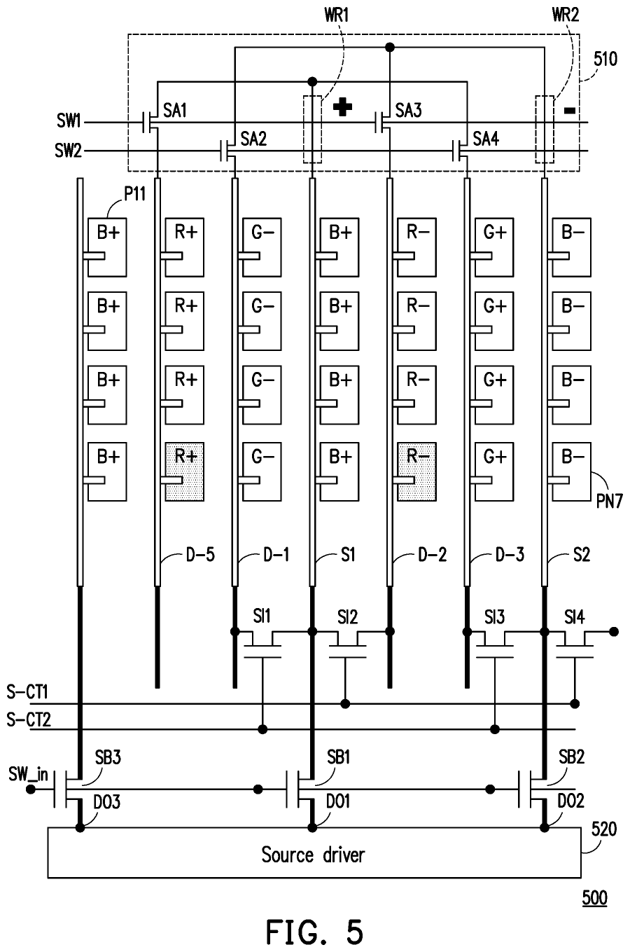

Referring to FIG. 5 hereinafter, FIG. 5 is a schematic diagram illustrating a display apparatus according to another embodiment of the invention. A display apparatus 200 includes a multiplexer 510, display pixels P11 to PN7, switches SI1 to SI4, data transmission switches SB1 to SB3 and a source driver 520. Different from the embodiments described above, the multiplexer includes transmission wires WR1, WR2 and multiplex switches SA1 to SA4, wherein the transmission wire WR1 is directly coupled to the selected data line S1 and coupled to first terminals of the multiplex switches SA1 and SA4, and second terminals of the multiplex switches SA1 and SA4 are respectively coupled to non-selected data lines D-5 and D-3. The transmission wire WR2 is directly coupled to the selected data line S2 and coupled to first terminals of the multiplex switches SA2 and SA3, and second terminals of the multiplex switches SA2 and SA3 are respectively coupled to non-selected data lines D-1 and D-2.

Additionally, the switch SI1 is coupled between the selected data line S1 and the non-selected data line D-1, the switch SI2 is coupled between the selected data line S1 and the non-selected data line D-2. The switch SI3 is coupled between the selected data line S2 and the non-selected data line D-3, and the switch SI4 is coupled between the selected data line S2 and the non-selected data line D-4. The switches SI1 and SI3 are controlled by the multiplex control signal S-CT2 to be turned on or turned off, and the switches SI1 and SI4 are controlled by the multiplex control signal S-CT1 to be turned on or turned off.

On the other hand, the source driver 520 has a plurality of data output endpoints DO1 to DO3 and is coupled to the data output endpoints SB1 to SB3 respectively via the data output endpoints DO1 to DO3. The data transmission switches SB1 to SB3 are respectively coupled to the selected data lines S1 to S3. The data transmission switches SB1 to SB3 are controlled by the data transmission control signal SW_in for being turned on or turned off. When the data transmission switches SB1 to SB3 are turned on, the source driver 520, via the data output endpoints DO1 to DO3, respectively transmits the display data to the selected data lines S1 to S3 via the data transmission switches SB1 to SB3. The data transmission switches SB1 to SB3 may be simultaneously turned on and turned off.

It should be additionally mentioned that in the present embodiment, the selected data line S1 may correspond to blue display pixels, the non-selected data line D-1 may correspond to green display pixels, the non-selected data line D-2 may correspond to red display pixels, the selected data line S2 may correspond to blue display pixels, and the non-selected data line D-3 may correspond to green display pixels.

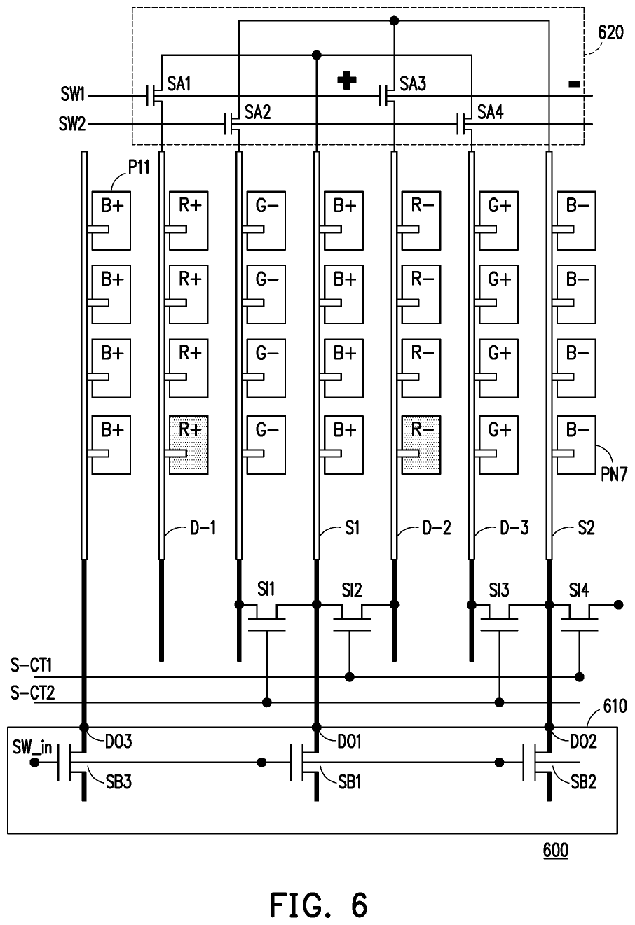

Referring to FIG. 6 hereinafter, FIG. 6 is a schematic diagram illustrating a display apparatus according to yet another embodiment of the invention. A display apparatus 600 includes a multiplexer 610, display pixels P11 to PN7, switches SI1 to SI4, data transmission switches SB1 to SB3 and a source driver 620. Different from the embodiments described above, the data transmission switches SB1 to SB3 are disposed in the source driver 620 and are coupled to the selected data lines S1 to S3 respectively via the data output endpoints DO1 to DO3. In the present embodiment, the data transmission control signal SW_in is generated inside the source driver 620 and configured to control whether to turn on the data transmission switches SB1 to SB3.

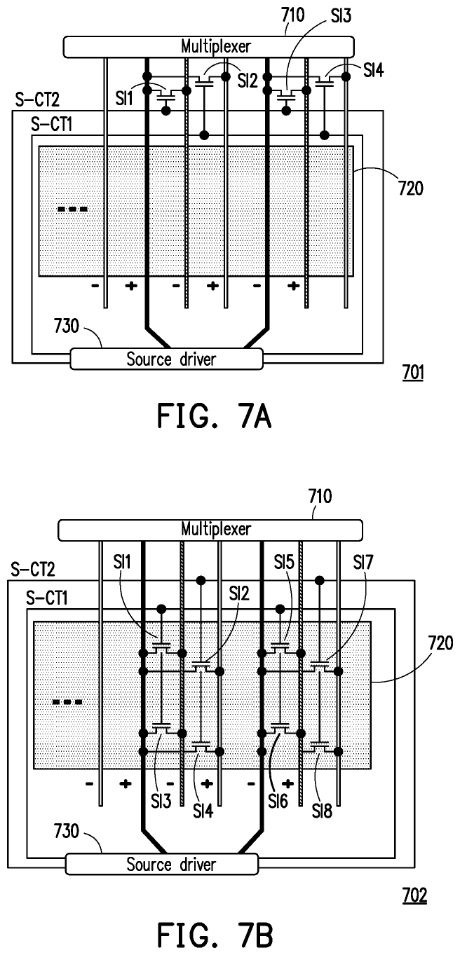

Referring to FIG. 7A and FIG. 7B hereinafter, FIG. 7A and FIG. 7B respectively illustrate disposition position relationships among a multiplexer, a plurality of pixel lines and switches according to different embodiments of the invention. In FIG. 7A, the pixel lines form a pixel array 720. A multiplexer 710 may be disposed at a first terminal (i.e., an upper terminal of the pixel array 720) of a display apparatus 701. A source driver 730 may be disposed at a second terminal (i.e., a lower terminal of the pixel array 720) of the display apparatus 701. Different from the embodiments described above (e.g., the embodiment as illustrated in FIG. 2), switches SI1 to SI4 may be disposed between the multiplexer 710 and the pixel array 720. In FIG. 7B, the multiplexer 710 may, in the same way, be disposed at a first terminal (i.e., an upper terminal of the pixel array 720) of a display apparatus 702. A source driver 730 may, in the same way, be disposed at a second terminal (i.e., a lower terminal of the pixel array 720) of the display apparatus 702. Switches SI1 to SI8 may be disposed (between a plurality of pixel lines) in the pixel array 720 including the plurality of pixel lines.

It is specially noted that in FIG. 7B, the switches SI1 and SI3 are connected in parallel to each other and may be respectively disposed in an upper region and a lower region of the pixel array 720. In this way, by turning on the switches SI1 and SI3 simultaneously, the efficiency of charge sharing may be improved to enhance pre-charge capability. Additionally, the switches SI2 and SI4, the switches SI6 and SI6 and the switches SI7 and SI8 may also have the same effect.

In FIG. 7A and FIG. 7B, both the control signals S-CT1 and S-CT2 are provided by the source driver 730.

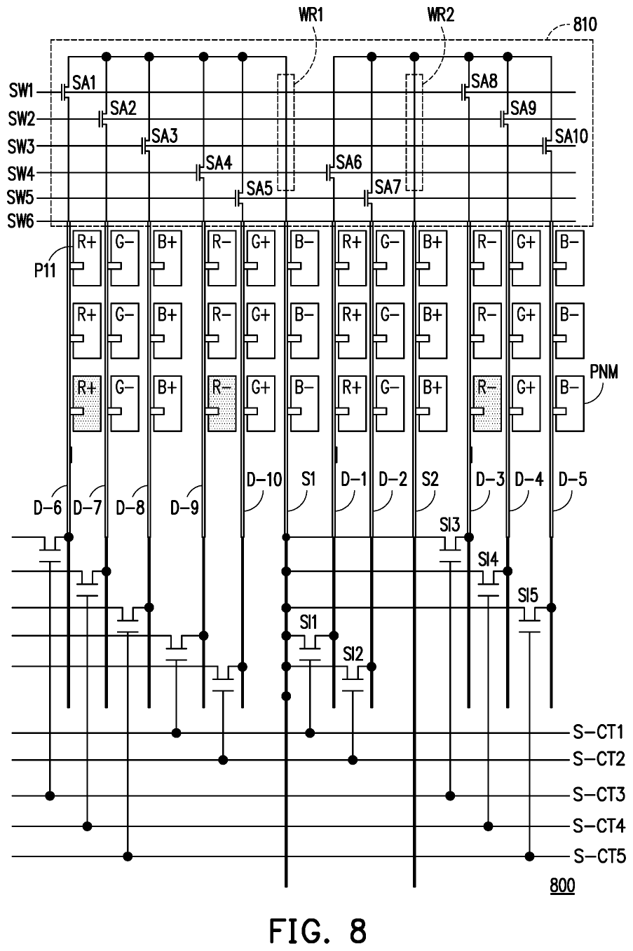

Referring to FIG. 8 hereinafter, FIG. 8 is a schematic diagram illustrating a display apparatus according to yet another embodiment of the invention. A display apparatus 800 includes a multiplexer 810, pixels P11 to PNNM and switches SI1 to SI10. In the present embodiment, the selected data line S1 may be coupled to a plurality of non-selected data lines D-1 to D-5 respectively via more switches SI1 to SI5. The switches SI1 to SI5 are respectively controlled by a plurality of control signals SCT1 to SCT5. Through the turning-on operation of the switches SI1 to SI5, one or more of the non-selected data lines D-1 to D-5 are pre-charged by the charges on the selected data line S1 via the switches SI1 to SI5 which are turned on.

Corresponding to the structure where more switches SI1 to SI5 are disposed, the multiplexer 810 includes transmission wires WR1, WR2 and a plurality of multiplex switches SA1 to SA10. Terminals of the multiplex switches SA1 to SA5 are coupled to the transmission wire WR1 in common, and other terminals of the multiplex switches SA1 to SA5 are respectively coupled to non-selected data lines D-6 to D-10. The transmission wire WR1 is directly coupled to the selected data line S1. Terminals of the multiplex switches SA6 to SA10 are coupled to the transmission wire WR2 in common, and other terminals of the multiplex switches SA6 to SA10 are respectively coupled to the non-selected data lines D-1 to D-5. The transmission wire WR2 is directly coupled to the selected data line S2.

In light of the foregoing, with the switches disposed between the selected data lines and the non-selected data lines and with the switches which are turned on, the invention can achieve pre-charging the display pixels on the non-selected data lines by the display data on the selected data lines, so as to improve the efficiency of the operation of writing data into the display pixels.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A display apparatus, comprising:
a plurality of pixel lines, respectively coupled to a plurality of data lines, and the data lines comprising a first selected data line and a plurality of other data lines;
a multiplexer, coupled to the data lines and controlled by a first multiplex control signal and a second multiplex control signal;
a first switch, coupled between the first selected data line and a first non-selected data line among the other data lines and turned on or turned off according to a first control signal; and
a second switch, coupled between the first selected data line and a second non-selected data line among the other data lines and turned on or turned off according to a second control signal.

2. The display apparatus according to claim 1, wherein the data lines further comprise a second selected data line, and the display apparatus further comprises:
a third switch, coupled between the second selected data line and a third non-selected data line among the other data lines and turned on or turned off according to the first control signal; and
a fourth switch, coupled between the second selected data line and a fourth non-selected data line among the other data lines and turned on or turned off according to the second control signal.

3. The display apparatus according to claim 2, wherein the first selected data line, the first non-selected data line and the second non-selected data line respectively correspond to display pixels in different colors.

4. The display apparatus according to claim 2, wherein the second selected data line, the third non-selected data line and the fourth non-selected data line respectively correspond to display pixels in different colors.

5. The display apparatus according to claim 2, wherein the multiplexer comprises:
a first transmission wire, directly coupled to the first selected data line;
a second transmission wire, directly coupled to the second selected data line;
a first multiplex switch, coupled between the second transmission wire and the first non-selected data line and controlled by the first multiplex control signal;
a second multiplex switch, coupled between the second transmission wire and the second non-selected data line and controlled by the second multiplex control signal;
a third transmission wire, directly coupled to a third selected data line;
a third multiplex switch, coupled between the third transmission wire and the third non-selected data line and controlled by the first multiplex control signal;
a fourth multiplex switch, coupled between the third transmission wire and the fourth non-selected data line and controlled by the second multiplex control signal.

6. The display apparatus according to claim 5, further comprising:
a source driver, having a plurality of data output endpoints; and
a plurality of data transmission switches, respectively coupled between the data output endpoints and the first transmission wire to the third transmission wire and controlled by a data transmission control signal.

7. The display apparatus according to claim 5, further comprising:
a source driver, having a plurality of data transmission switches and a plurality of data output endpoints, the data transmission switches being respectively coupled to the data output endpoints, and the data output endpoints being respectively coupled to the first transmission wire to the third transmission wire,
wherein the data transmission switches are controlled by a data transmission control signal.

8. The display apparatus according to claim 2, wherein the multiplexer comprises:
a first transmission wire, directly coupled to the first selected data line;
a second transmission wire, directly coupled to the second selected data line;
a first multiplex switch, coupled between the first non-selected data line and the second transmission wire and controlled by the second multiplex control signal;
a second multiplex switch, coupled between a fifth non-selected data line and the first transmission wire and controlled by the first multiplex control signal;
a third multiplex switch, coupled between the second transmission wire and the second non-selected transmission wire and controlled by the first multiplex control signal; and
a fourth multiplex switch, coupled between the third non-selected data line and the first transmission wire and controlled by the second multiplex control signal.

9. The display apparatus according to claim 2, wherein the first selected data line sequentially transmits first color display data and second color display data, and when a strength of the first color display data is greater than a strength of the second color display data, the first switch is turned on according to the first control signal in a first time zone,
wherein the first time zone occurs in a transition time zone when a signal on the first selected data line is transited from the first color display data to the second color display data.

10. The display apparatus according to claim 9, wherein the first selected data line transmits third color display data after the second color display data, and when a strength of the second color display data is greater than a strength of the third color display data, the second switch is turned on according to the second control signal in a second time zone,
wherein the second time zone occurs in a transition time zone when a signal on the first selected data line is transited from the second color display data to the third color display data.

11. The display apparatus according to claim 2, wherein the multiplexer is disposed at a first terminal of the display apparatus, a source driver of the display apparatus is disposed at a second terminal of the display apparatus, and the pixel lines are disposed between the multiplexer and the source driver.

12. The display apparatus according to claim 11, wherein the first switch, the second switch, the third switch and the fourth switch are disposed in common at the second terminal of the display apparatus and are adjacent to the source driver.

13. The display apparatus according to claim 11, wherein the first switch, the second switch, the third switch and the fourth switch are disposed in common at the first terminal of the display apparatus and adjacent to the multiplexer.

14. The display apparatus according to claim 11, wherein the first switch, the second switch, the third switch and the fourth switch are disposed in common in the pixel lines.

15. The display apparatus according to claim 2, further comprising:
at least one fifth switch, coupled between the first selected data line and at least one fifth non-selected data line among the other data lines and turned on or turned off according to at least one third control signal; and
at least one sixth switch, coupled between the second selected data line and at least one sixth non-selected data line among the other data lines and turned on or turned off according to at least one fourth control signal.
